(19) United States
(12) Patent Application Publication
(10) Pub. No.: US 2015/0161233 A1
(43) Pub. Date: Jun. 11, 2015

(54) Customer energy consumption segmentation using time-series data

(71) Applicant: The Board of Trustees of the Leland Stanford Junior University, Palo Alto, CA (US)

(72) Inventors: June Flora, Menlo Park, CA (US); Jungsuk Kwac, Stanford, CA (US); Ram Rajagopal, Palo Alto, CA (US)

(21) Appl. No.: 14/567,615

(22) Filed: Dec. 11, 2014

Related U.S. Application Data
(60) Provisional application No. 61/914,681, filed on Dec. 11, 2013.
(60) Provisional application No. 61/914,703, filed on Dec. 11, 2013.

(51) Int. Cl. G06F 17/30

(52) U.S. Cl. CPC G06F 17/30598

(57) ABSTRACT

Utility customer segmenting according to consumption lifestyle features is performed by collecting from smart meter sensors time-series utility consumption data from individual utility customers, standardizing the consumption data by dividing the time-series data into daily consumption profiles, generating a consumption profile dictionary from the standardized data, encoding the standardized data using the dictionary, extracting consumption lifestyle features of the utility customers from the encoded data, and segmenting the customers based on the extracted features by clustering.

### CROSS-REFERENCE TO RELATED APPLICATIONS

This application claims priority from U.S. Provisional Patent Application 61/914,681 filed Dec. 11, 2013 and from U.S. Provisional Patent Application 61/914,703 filed Dec. 11, 2013, both of which are incorporated herein by reference.

### STATEMENT OF GOVERNMENT SPONSORED SUPPORT

This invention was made with Government support under grant (or contract) no. DE-AR0000018 awarded by the Department of Energy. The Government has certain rights in the invention.

### FIELD OF THE INVENTION

The present invention relates generally to systems and methods for analyzing resource consumption patterns of utility customers.

### BACKGROUND OF THE INVENTION

After utilities deploy large numbers of advanced metering infrastructure meters, i.e., smart meters, across their distribution grids, they are challenged with managing a massive set of 1-hour or 15-minute interval energy consumption data and decoding the information into meaningful measures that can be helpful to them. Also, with the emerging smart grid technologies becoming ubiquitous, utilities must expand their focus from service reliability to service marketability. Because customers vary widely in their usage, needs, and suitability for different programs and pricing packages, this is a challenging, unsolved problem in the industry.

### SUMMARY OF THE INVENTION

Existing approaches to analyzing utility customer data rely on demographic variables to segment consumers and target them without high resolution consumption data. The approach of the present invention avoids this problem by incorporating time-series consumption data into customer segmentation by appropriate feature (metric) extraction for a given purpose.

The smart meter data provides a unique opportunity to understand a customer's energy use for any data-driven energy management plan. Defining and describing different customer segments will provide decision makers with information to advance not only in pricing and program marketing, but also resource allocation and program development. More intimate modeling and analysis of customer behavior can aid utilities in planning ahead instead of reacting to what has already occurred. Among many key applications, customer lifestyle segmentation can unlock potential energy savings and can help utilities understand operating requirements and better coordinate energy resources for grid management.

In one aspect, the invention provides a method to segment customers' lifestyles based on their utility resource consumption data using the pre-processed load-shape dictionary. Hourly data gathered from residential smart meters is used to empirically define customer segments that can be approached for achieving higher returns in energy programs, such as demand response (DR). The segmentation method uses an encoding system with a pre-processed load shape dictionary that is used to classify customers according to extracted features such as entropy of shape code which measures the amount of variability in consumption. Load shape information enhances our ability to understand individual as well as groups of consumers. For example, time of day building occupancy and energy consuming activities can be interpreted from these shapes.

Significant features of embodiments of the invention include the full data-driven approach, including a segmentation that can be directly used for energy program targeting, various metrics themselves which can be used for improve targeting performance, and the scalable segmentation process that can work well even on huge amount of data.

In one aspect, the invention provides a methodology that utilizes energy consumption (electricity, gas or water) data from individual utility consumers to segment the customers based on various features (e.g., lifestyle features). The methodology may include, as appropriate, (1) customer energy consumption profile dictionary generation, (2) customer (energy consumption) lifestyle segmentation, and/or (3) various energy consumption feature (or metric) extraction processes. The method has applications to segmenting the customers based on their lifestyle features and can be used to enhance targeting recruitment in utility programs (demand response, energy efficiency) by utilizing proper energy consumption features (or metrics).

Embodiments of the invention decompose the daily usage patterns into daily total usage and a normalized daily load shape. Representative load shapes are found utilizing clustering algorithms (in particular, adaptive K-means) and summarized utilizing hierarchical clustering, so a stable encoding mechanism can be designed. Various features and metrics can be extracted from the encoded data by the encoding system provided by embodiments of the invention.

Embodiments of the invention provide several different segmentation schemes that can be selected for certain program development, pricing, and marketing purposes, e.g., there are five segmentation analyses in one of the papers attached. The invention also significantly provides how to do customer energy consumption lifestyle segmentation with a scalable approach.

Many features can be extracted from load shapes. In DR programs, peak usage fraction, peak time and peak duration can be important features to better control the demand at peak time. For EE programs, important information are features which can be used as proxy variables of the existence of specific appliances and their efficiency. For example, load sensitivity to temperature during summer can be a proxy variable of air conditioner existence. Besides, many other features can be extracted from this raw usage data depending on the interests of possible programs.

According to one aspect, the invention provides a method implemented by a computer for segmenting utility customers according to consumption lifestyle features. The method includes collecting by the computer from smart meter sensors time-series utility consumption data from individual utility customers; standardizing by the computer the collected time-series utility consumption data by dividing the time-series data into daily consumption profiles; generating by the computer a utility customer consumption profile dictionary from the standardized data, where the dictionary comprises representative load shapes found using clustering; encoding by the computer the standardized data, wherein the encoding comprises producing a series of dictionary codes using a distance metric and the dictionary of representative load shapes; extracting by the computer consumption lifestyle features of the utility customers from the encoded data; and segmenting by the computer the customers based on the extracted features by clustering (e.g., adaptive K-means clustering, which may using distance metric such as cosine between feature lifestyle vectors).

The time-series utility consumption data preferably represent resource use per unit time for each customer. The representative load shapes in the dictionary may be found using adaptive K-means and hierarchical clustering. Each of the lifestyle features of the utility customers is preferably a dictionary code distribution vector for each customer. The segmenting of the customers may include adaptive K-means clustering using a distance metric to measure the distance between feature lifestyle vectors. In some embodiments, the segmentations of customers may be used to estimate customer performance in a utility program. The method may also include presenting to customers information about their typical patterns of consumption and savings. The method additionally may include designing pricing of the utility resource based on the encoded patterns, and/or targeting customers with utility programs based on the segmentations. A load shape predictor may be implemented in some embodiments to predict a future load shape from the encoded data, and predicting daily consumption from the predicted load shape and an estimate of daily total consumption.

### BRIEF DESCRIPTION OF THE DRAWINGS

FIG. 1 is a flow diagram schematically illustrating an overview of a method of customer data segmentation according to an embodiment of the invention.

FIG. 2 illustrates a data standardization process which forms a step in the method shown in FIG. 1, according to an embodiment of the invention.

FIG. 3 illustrates a dictionary generation process which forms a step in the method shown in FIG. 1, according to an embodiment of the invention.

FIG. 4 illustrates a data encoding process which forms a step in the method shown in FIG. 1, according to an embodiment of the invention.

FIGS. 5A-B illustrate two examples of a segmentation process which forms a step in the method shown in FIG. 1, according to an embodiment of the invention.

FIG. 6 is a schematic overview of a system implementing a method for customer data segmentation according to an embodiment of the invention.

FIG. 7 is an overview of the main steps of a method for customer data segmentation according to an embodiment of the invention.

### DETAILED DESCRIPTION

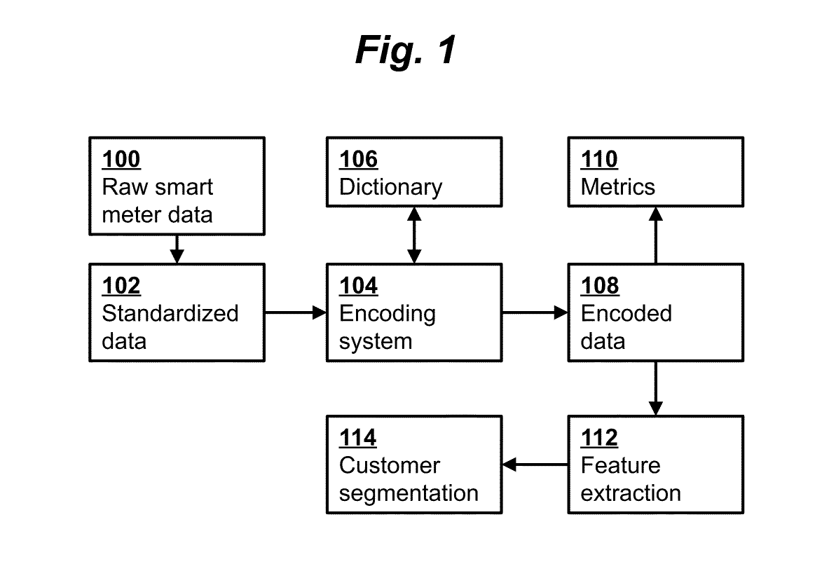

An overview of a preferred embodiment of a method for utility customer segmentation based on energy consumption data is shown in FIG. 1. Raw smart meter data 100 representing utility customer resource use is collected from smart meters. The raw data is then standardized 102 to produce standardized data which is then encoded by an encoding system 104 using an encoding dictionary 106. The encoded data 108 is then processed by a feature extraction process 112 to extract features (e.g., consumption lifestyle features) of the utility customers. Each of the lifestyle features of the utility customers is preferably a dictionary code distribution vector for each customer. These extracted features are then used in a customer segmentation step 114 to segment the customers based on the extracted features by clustering (e.g., adaptive K-means clustering, which may using distance metric such as cosine distance between lifestyle feature vectors). The encoded data 108 is also used to generate metrics 110. Metrics can be considered as features in a broad sense. Encoded data does not have to be used only to extract features in segmentation, but it can be also used to show certain metrics as they are if appropriate to help utilities design or manage energy programs. The metrics may be some relevant features extracted in 112 and other features calculated by binding the encoded data to temperature data, demographics data or survey data.

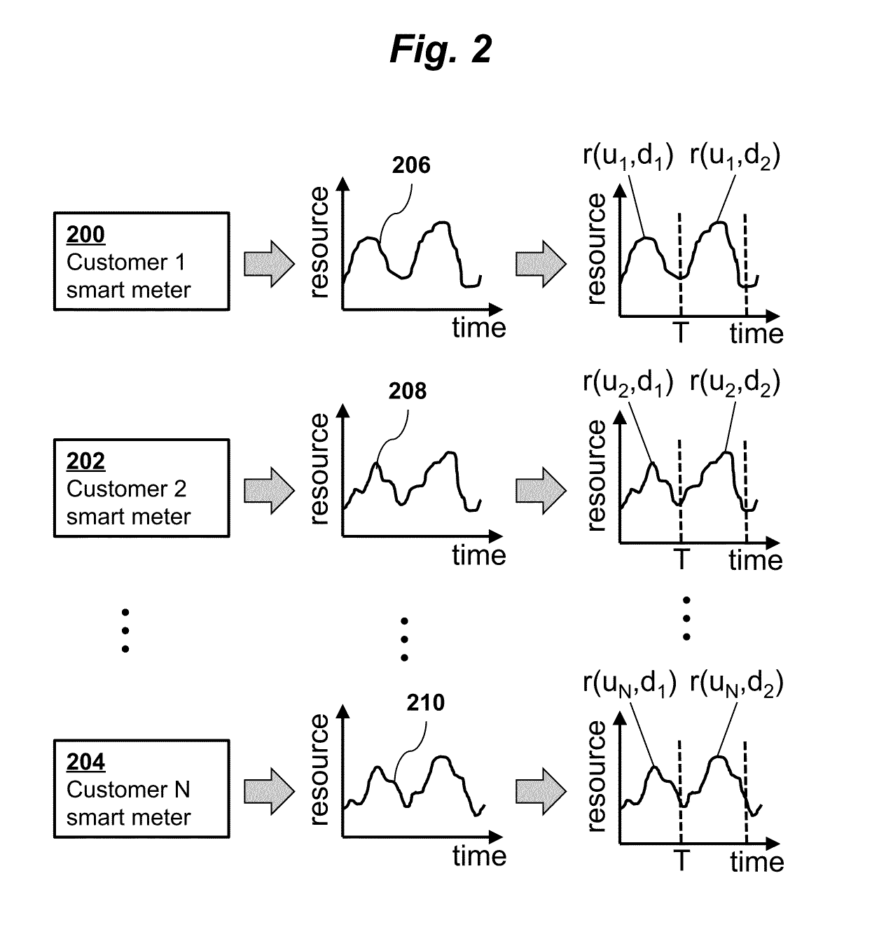

The data standardization process 102 of FIG. 1 is illustrated in more detail in FIG. 2. Smart meter data from N customer smart meters 200, 202, through 204 is collected as high resolution time-series data representing resource use per unit time, as illustrated in the graphs 206, 208, through 210. The smart meter raw consumption data may represent the consumption of any of various types of utility resource (e.g., gas, water, electricity). To facilitate processing the data from many customer smart meters in a consistent format, the data is standardized. Part of the standardization process includes dividing a customer's consumption time-series data into daily consumption profiles. The time-series data 206 for user 1 is divided by a time period T (e.g., T=24 hours=1440 minutes) into profiles r(u₁,d₁) and r(u₁,d₂) where d₁ and d₂ are indices representing the day. Similarly, time-series data 208 for user 2 is divided into profiles r(u₁,d₁) and r(u₂,d₂), and time-series data 210 for user N is divided into profiles r(u_{N},d₁) and r(u_{N},d₂). The data standardization may also include other data cleansing techniques: anomaly detection with constraints, missing data imputation by linear interpolation or k-nearest neighbor algorithm.

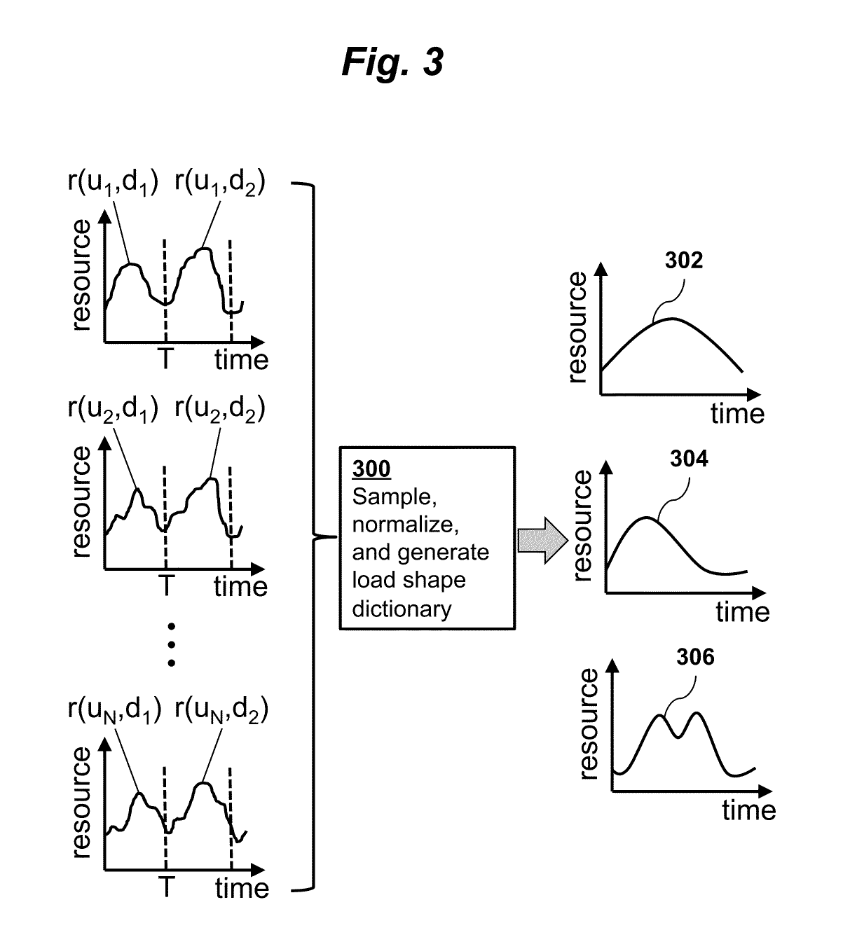

FIG. 3 illustrates details of the encoding system (step 104 of FIG. 1), specifically the generation of the pre-processed load shape dictionary of codes from the standardized profile data. In step 300 the standardized daily consumption profiles {r(uᵢ,dₖ)} for all users and days is sampled (if the overall sample size is not too big, all profiles can be used), and the sample is normalized (e.g., using L1 norm or L2 norm). The normalized profiles are then used to generate a consumption pattern code dictionary. For example, the dictionary may include codes 302, 304, 306, denoted C1, C2, C3. The dictionary codes are representative load shapes found by clustering the normalized profiles. For example, the representative load shapes in the dictionary may be found using adaptive K-means and hierarchical clustering. A load shape is an example of a feature that can be extracted from the consumption data and is useful for representing a customer consumption lifestyle.

The dictionary contains K representative load shapes Cᵢ(t). Every load shape in the data is mapped to the closest shape code. Load shape s(t) is assigned to center i*(s)=arg minᵢ E(s,i) that minimizes the squared error E(s,i)=(Cᵢ(1)−s(1))²+ . . . +(C,(24)−s(24))² in case that load shape clustering utilizes Euclidean distance. The encoding procedure also records the minimum squared error E(s,i*(s)) for each encoded shape. The total energy is characterized by its quantile according to a mixture of log normal distributions. Various properties can be directly computed on the load shape dictionary.

Note that given a load shape s^{k}ₙ(t) for day n for customer k, we can identify a sequence of shape codes, a sequence of total consumption values and the sequence of errors E(s^{k}ₙ,i*(s^{k}ₙ)). To reduce notation burden, whenever possible we omit the customer index k.

The dictionary is generated to have a good coverage, meaning every load shape in the data is sufficiently close to some representative shape. A good dictionary is also consistent, meaning that executing the learning procedure in different subsets of the population returns representative load shapes that are not too far from each other.

Another useful feature is a load-shape segment. From this load-shape segment information, we can know when customers consume the energy actively at home and conjecture the times the home is occupied. For example, load shapes can be divided into 7 load-shape segments depending on the peak time: Morning peak (M: 4:00-10:00), Daytime peak (D: 10:00-16:00), Evening peak (E: 16:00-22:00), Night peak (N: 0:00-4:00, 22:00-24:00), Dual peak Morning & Evening (Du M&E), Dual peak Evening & Night (Du E&N), Dual peak Daytime & Evening (Du D&E). Note that there can be other combinations (e.g., Du M&D, Du M&N, Du D&N) in load-shape segments, however, load shapes are rarely included in those segments. Thus, a daily consumption pattern can be encoded as one of these seven load-shape segments.

Another useful feature is ranking of binned usages. From the load-shape segment feature, dual peak segments are mapped from a load-shape dictionary manually based on reasonable interpretation of the load shapes. Moreover, the load-shape segment feature captures the peak hours, but doesn't capture the overall consumption amount change in a day as the daily load shape does. The ranking of binned usages (RBU) uses the same four division of a day as the load-shape segment feature: Morning (M), Daytime (D), Evening (E), Night (N). The ranking of four binned usages can be 24 cases, e.g., “MDEN” if the consumption in the morning is the largest and the consumption in the daytime is the second largest. This feature can be easily mapped from the load-shape dictionary or calculated from the raw data. It can be interpreted as a rougher compression of the original data than a load-shape dictionary code. Because most active consumption is in the two top bins, if only the two top bins are ranked, this feature can be encoded with 12 codes: {MD, ME, MN, DM, DE, DN, EM, ED, EN, NM, ND, NE}.

In some embodiments, the dictionary can vary depending on features used to encode. For example, if we encode the closest load shapes from the raw consumption profiles, the load shape dictionary should be created properly. Alternatively, the dictionary can be created using certain features, e.g., load shape segment or any other features which can be calculated from the raw data. Also, in generating the dictionary, the technique does not have to be confined while adaptive K-means plus hierarchical clustering is used on sampled daily profiles. It can be classical K-means or any advanced clustering method with appropriate distance metric and dictionary size setting. The main concept is how to represent well the behavior, consumption pattern or other relevant metrics of huge population by small number of dictionary elements with minimum loss in representative power or in concerned information.

In the case where the dictionary is generated from a small sample, a verification may be performed after generating the dictionary to check whether the dictionary from sampled data faithfully represents the characteristics (e.g., consumption profiles) of the entire data set. The dictionary may be generated using various techniques including K-means, adaptive K-means, hierarchical clustering, or a combination of adaptive K-means and hierarchical clustering.

In general, setting a proper K is always a trade-off between simplicity of segmentation and accuracy of representativeness. When K, the number of groups, is high, the representative of each clustered group will describe its group members well. However, a high K may not be practical with less interpretability. It is important to reduce the number of load shapes with minimum sacrifice in accuracy of representativeness. In a preferred embodiment, 2-stage clustering (adaptive K-means plus hierarchical clustering) is applied, and the top N load shapes which cover 90% of total load patterns are selected.

we propose an adaptive K-means algorithm with a threshold to construct the shape dictionary ([5]). The algorithm starts by a set of initialized cluster centers utilizing a standard K-means algorithm, with an initial K=k₀. Adaptive K-means then adds additional cluster centers, whenever a load shape s(t) in the dataset violates the mean squared error threshold condition

E(s,i*(s))=(s(1)−C_{i*(s)}(1))²+ . . . +(s(24)−C_{i*(s)}(24))²≦θ{(C_{i*(s)}(1))^{2+ . . . +(}C_{i*(s)}(24))²}

where θ is the threshold choice. The threshold provides flexibility to cope with various practitioners' needs and control of the statistical properties of the load shapes in the same group. Since load shapes are normalized, each cluster center resulting from K-means is also normalized as they are the average of the member shapes. This guarantees that distances on both sides of the threshold condition above are bounded, and it is easy to demonstrate the range 0≦θ≦2 is required for non-trivial solutions. The main differentiation of the proposed algorithm from previous approaches is that the threshold test is utilized to dynamically split clusters that do not satisfy the condition. Together with the normalization utilized in the load shapes, it results in more robust dictionaries and better properties for the algorithm.

The resulting representative shape dictionary from K-means can be highly correlated as the adaptive K-means algorithm does not guarantee an optimal distance between cluster centers, and instead meets a threshold θ for every cluster. For interpretability and analysis, it is interesting to relax this condition for some clusters. Some embodiments thus use a simple hierarchical clustering algorithm to merge clusters whose centers are too close. The algorithm reduces the dictionary to a target size T by merging clusters. The weighted average is exactly the new cluster mean.

It is important to understand the purpose of the two stage clustering for generating the dictionary. If the dictionary size T is set directly, the performance is similar to classical K-means. However, classical K-means does not guarantee that every load shape is within a certain range of the cluster center. Adaptive K-means is needed to find proper K satisfying the desired threshold condition. Except that under this hard constraint, a number of small clusters can arise. Hierarchical clustering is utilized to filter and consolidate these small clusters to result in a small and stable dictionary, that is meaningful in practice.

In some embodiments, separate encodings may be learned and/or selected based on a season, industry, or other side variable.

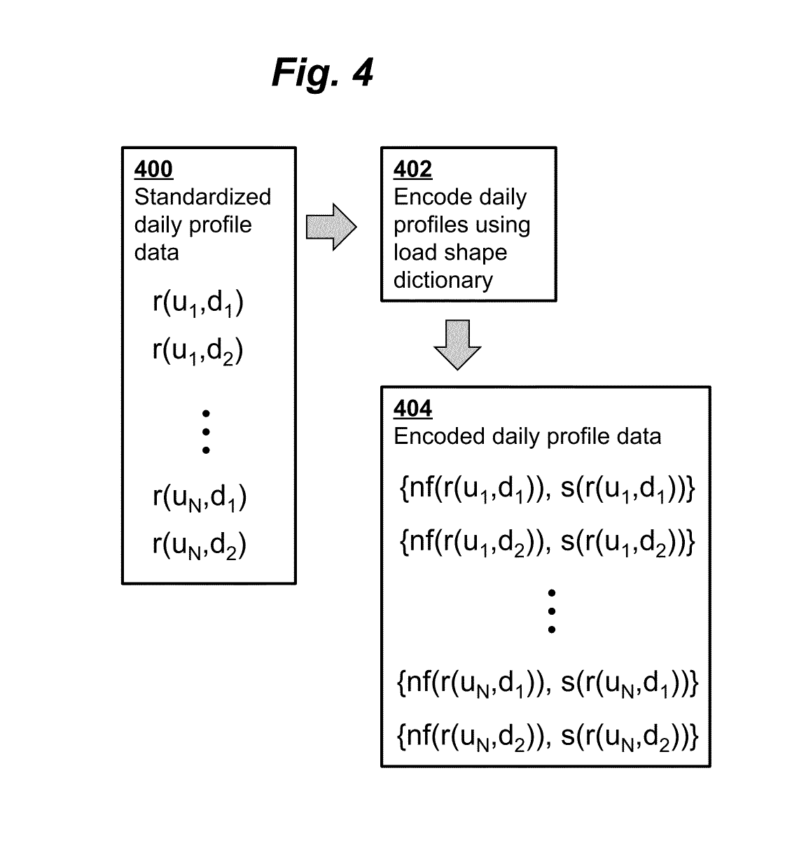

FIG. 4 illustrates further details of the encoding system (step 104 of FIG. 1), specifically the step of using the generated load shape dictionary to encode the standardized daily consumption profile data 400. The encoder 402 encodes each daily profile of a customer (whether residential or commercial) to the closest load shape code from the dictionary and the daily consumption (corresponding to normalization factor), producing a corresponding set of encoded data, which is highly compressed. For example, r(u₁,d₁), which is a time-series set of data for user 1 for day 1, is encoded as a pair of numbers {nf(r(u₁,d₁)), s(r(u₁,d₁))}, where nf(r(u₁,d₁)) is a normalization factor corresponding to the L1 norm of r(u₁,d₁), and where s(r(u₁,d₁)) is the closest shape code in the dictionary to r(u₁,d₁), where distance is measured using the L1 norm. In alternate embodiments the L2 norm, minimum squared distance, or another norm may be used.

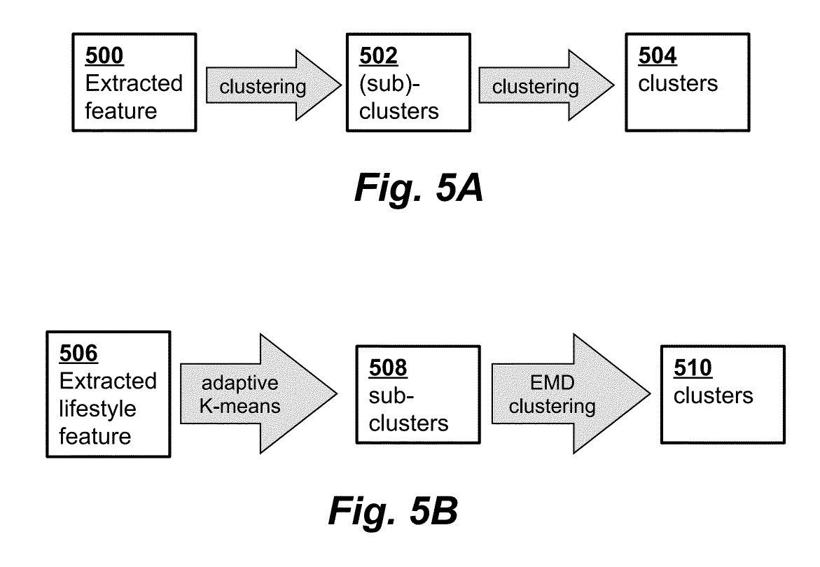

Details of customer segmentation step 114 of FIG. 1 are illustrated in FIGS. 5A-B. FIG. 5A shows the general case and FIG. 5B illustrates an example which is a specific case. In the general case, extracted feature 500 is used as a basis for clustering the customers into distinct segmented sub-clusters 502. Optionally, depending on the number of clusters from the first clustering and interpretability, an additional clustering process may be used to integrate or merge the sub-clusters to smaller number of clusters 504. For the second clustering, any type of proper clustering method can be applied. For example, hierarchical clustering with complete linkage based on the earth mover's distance (EMD), which is the minimum effort (cost) dₘₒᵥ(a,b) of turning one load shape a into another load shape b; where the effort is assumed to be amount of normalized usage moved times the hours by which it is moved. For two different load shapes, the i-th load shape sᵢ(t) and the j-th load shape, sⱼ(t), we can define this new distance metric,

d(sᵢ(t),sⱼ(t)=|EMD₁|+ . . . +|EMD₂₄|,

where EMD₀=0, and EMDₖ₊₁=(sᵢ(k)+EMDₖ₎₋ₛⱼ(k). We can then define a distance matrix M with elements Mᵢⱼ=d(sᵢ(t),sⱼ(t)). The distance metric between two sub-clusters (obtained by adaptive K-means) can be defined as the distance metric between the sub-clusters' centers, considered as lifestyle vectors. The minimum cost dₘₒᵥ(a,b) can be obtained by solving the linear programming (LP) problem defined by

dₘₒᵥ(a,b)=minΣ_{i,j}MᵢⱼX_{i,j}s.t.Σ_{i,j}Xᵢⱼ=1,Xᵢⱼ≧0,ΣᵢXᵢⱼ=bⱼ,ΣⱼXᵢⱼ=aᵢ,

where X is the transition matrix and Xᵢⱼ is the probability that the i-th load shape of one customer matched to the j-th load shape of another. Preferably, the distance metric, dₘₒᵥ(a,b), is not used when the lifestyle vectors are clustered in the first step because the number of customers is too big. Thus, at first, the number of representative lifestyle vectors should be reduced by adaptive K-means clustering. Then, dₘₒᵥ(a,b) can be used as another distance metric, to integrate the resulting fewer clusters based on the actual similarity among load shapes. As an alternative to calculating dₘₒᵥ(a,b) using the LP problem, it may be calculated more efficiently using the following algorithm, where I is the array of two subscript indices for the ascending order of elements in M.

```
dₘₒᵥ(a,b)=0
for (i,j) in I do
    base = min(aᵢ,bⱼ)
    if base > 0 then
        aᵢ=aᵢ−base
        bⱼ=bⱼ−base
        dₘₒᵥ(a,b)=dₘₒᵥ(a,b)+Mᵢⱼ*base
    end if
end for
```

In the specific case shown in FIG. 5B, an extracted lifestyle feature of the utility customers 506 (e.g., a dictionary code distribution vector for each customer) is used to segment the customers using adaptive K-means clustering (e.g., using distance metric such as cosine distance between feature lifestyle vectors) to generate sub-clusters of customers 508. Optionally, hierarchical clustering with complete linkage based on the earth mover's distance (EMD) may then be applied, as in the general case described in FIG. 5A, to generate segmented customer clusters 510.

Once the customers have been segmented, it can be used or applied in various ways. Depending on what kind of feature is extracted from the encoded results, various types of segmentations and analyses can be done. For example, if the feature is “entropy”, the segmentation would result in an “Entropy analysis”.

The segmentations of customers may be used to estimate customer performance in a utility program, to present to customers information about their typical patterns of consumption and savings, to design pricing of the utility resource based on the encoded patterns, and/or targeting customers with utility programs based on the segmentations. For example, in the case where the developed segmentations are used to estimate program performance, customer performance in a utility program is measured before enrollment and after enrollment (for example, demand response). Then program performance is computed per segment rather than in aggregate. Program response can be predicted by utilizing predictive models that utilize segments as indicators and additional derived features from the encoded load shapes. So for customer i, if his demand response savings is yᵢ on average, then we build a predictive model yᵢ=h(cᵢ, fᵢ), where cᵢ are fixed characteristics of consumer i, and fᵢ are features derived from the segment customer i belongs to. Alternatively a separate response function h is found for each customer segment. The encoded representation may also be used to provide baselines for measurement and validation of program performance. Baselines can be defined for each customer based on the customer segment or directly based on the encoded pattern (rather than raw data).

Embodiments may also include deriving metrics (FIG. 1, 110) for each customer from the encoding. These metrics may include variance, quantiles of quantity, entropy, average quantile, daily peak timings, daily peak hour locations. A combination of metrics derived from the encoding may then be used to target customers to programs.

Targeting programs may be based on the derived segments for consumers. Given a number of segments, a program is targeted and based on the performance, certain segments are offered the program more than others.

Some embodiments may include clustering customers into data-driven segments by using additional clustering mechanisms. Such segments can be formed according to (1) behavioral traits (e.g., single peak consumers, double peak), (2) according to timing of consumption (morning, afternoon, etc.), (3) using advanced algorithms (EMD, K-means clustering).

In another application, encoded representations of customers may be used to present information to consumers about their typical patterns of consumptions and savings as they experience alternative patterns of consumption.

The encoded patterns may also be used to design pricing of the utility resource (electricity, water): the encoded patterns are utilized in an optimization to design customized pricing for each consumer or for each segment of consumers.

A load shape predictor may be implemented in some embodiments to predict a future load shape from the encoded data, and predicting daily consumption from the predicted load shape and an estimate of daily total consumption.

The load shape predictor which can be implemented on the series of encoded dictionary codes by utilizing some Markov chain models or advanced classification models. Once the load shape predictor is created, load prediction is also possible as it only needs to predict the daily consumption which can be done with various existing load prediction methods. If we can estimate 1) the load shape and 2) daily total consumption for tomorrow, it means we can predict the load for every hour tomorrow as it is just the multiplication of (1) and (2).

The techniques of the present invention can be used to drive improvements in peak load forecasting for a power system zone. If predicting total peak load for a particular hour, only a subset from the set of customers that are in a relevant class influence such forecast. Therefore, additional information collected about such customers could significantly increase the prediction accuracy. Moreover, the approach can inform load forecasting about individual households. Such forecasting is important for design of micro-grids and intelligent distribution systems. The methodology suggests that different consumer classes might require different forecasting approaches. In particular, customers can be classified according to entropy. Low entropy consumers are easier to forecast at an individual level, and high entropy consumers are harder to forecast since they have significantly more variability. Moreover, in analyzing the performance of forecasting, it is important to distinguish the differences for the various classes.

This method could also drive algorithms for load or load shape forecasting for individuals. After the encoding procedure, each household would have a sequence of load shape code and one of daily consumption. Load shape can be forecasted using various Markov chain type methods or advance classification algorithms after reducing the size of the load shape dictionary. With those results, any daily consumption prediction method can be merged to forecast the load at a specific time.

Moreover, customer segmentation based on their lifestyles (energy consumption lifestyles) is also possible with the definition of “lifestyle vector”, i.e., the dictionary code distribution vector for each customer. For example, if the load shape dictionary is composed of five codes and a customer has equal number of each load shape over a certain period, then the customer's lifestyle vector would be, for example, (0.2, 0.2, 0.2, 0.2, 0.2). More rigorously, a resource consumption lifestyle of a customer is defined as the probability distribution vector of a given lifestyle feature. To obtain such a vector, a lifestyle function LS(i,fⱼ|c)=(p₁, . . . p_{|fj|}) is developed, where j is the feature index, i is the customer index, f is the j-th lifestyle feature, c represents constraints on the consumption data, and p₁+ . . . +p_{|fj|}=1. For example, if c is “weekends,” LS( ) outputs a lifestyle vector only from consumption data of weekends.

Based on this feature, lifestyle vector, customers can be clustered by K-means with proper distance metric. For example, if we consider the encoded dictionary codes as a text, cosine dissimilarity based K-means may be a classical approach. In case that the length of lifestyle vector is long (the dictionary size is large), ISOMAP, MDS or other various dimension reduction methods can be applied to help the lifestyle segmentation. Characterization of a customer may be thereby accomplished based on the dictionary using frequencies from the load shapes in the dictionary (“lifestyle vector”). In addition, or alternatively, characterization of a customer may be accomplished using Bayesian models, Bayesian hierarchical models, sparse statistical models, discrete choice models, and/or behavioral economics models.

Additionally, over this load shape based segmentation, multidimensional segmentation can be done by combining other segmentation criteria. For example, consumption amount based segmentation can be combined to achieve more detailed segmentation. In commercial data, NAICS (North American Industry Classification System) code categorization can be combined. Also, deeper analysis is possible after adding temporal or spatial locality conditions, and/or climate. Many other types of clustering are possible based on the features of interest.

Briefly, the (load shape) dictionary concept is very important because it is the starting point of many applications with enabling efficient feature extraction and segmentation. For example, suppose there are 100 features of interest on huge size of energy consumption data of large population. Using the techniques of the present invention, it is sufficient to replicate the extracted features from the load shapes in the dictionary (with the scaling factor if needed) according to encoded dictionary codes. Without the dictionary, one would need to extract every feature from the raw data, which is much more inefficient. Moreover, considering the number of entire population and the consumption data generation speed, it is very hard to keep all the raw data. Encoding based on a properly generated dictionary can compress the raw data significantly.

Moreover, the size of load shape dictionary can be reduced much more. About 270 load shapes covers 90% of overall consumption patterns. If we ignore or reduce the rest of the load shapes, we can achieve a more compressed version of the load shape dictionary. For example, the dictionary size is reduced to 200 with proper supporting facts. Additionally, if we aggregate the customers onto a feeder level or a zip code level, the number of load shapes can be reduced much more. This load shape dictionary enables many types of applications. For example, it makes it easier to train the load shape prediction model and predict the load shape as a multiclass classification problem. Then this can be a milestone in the decentralized control system of smart grid networks.

In preferred embodiments, the invention makes use of a new machine learning algorithm. In generating the load shape dictionary, we use adaptive K-means plus hierarchical clustering. A unique feature is that adaptive K-means algorithm is modified so that it does not require a predetermined K and can guarantee some statistical property on clustered results by providing a certain threshold condition. Also, the threshold condition is flexible. There can be various threshold conditions: e.g. the L_{k (k=}1, 2, . . . , ∞) distance should be less than a certain threshold. For any threshold condition, the same algorithm can be used.

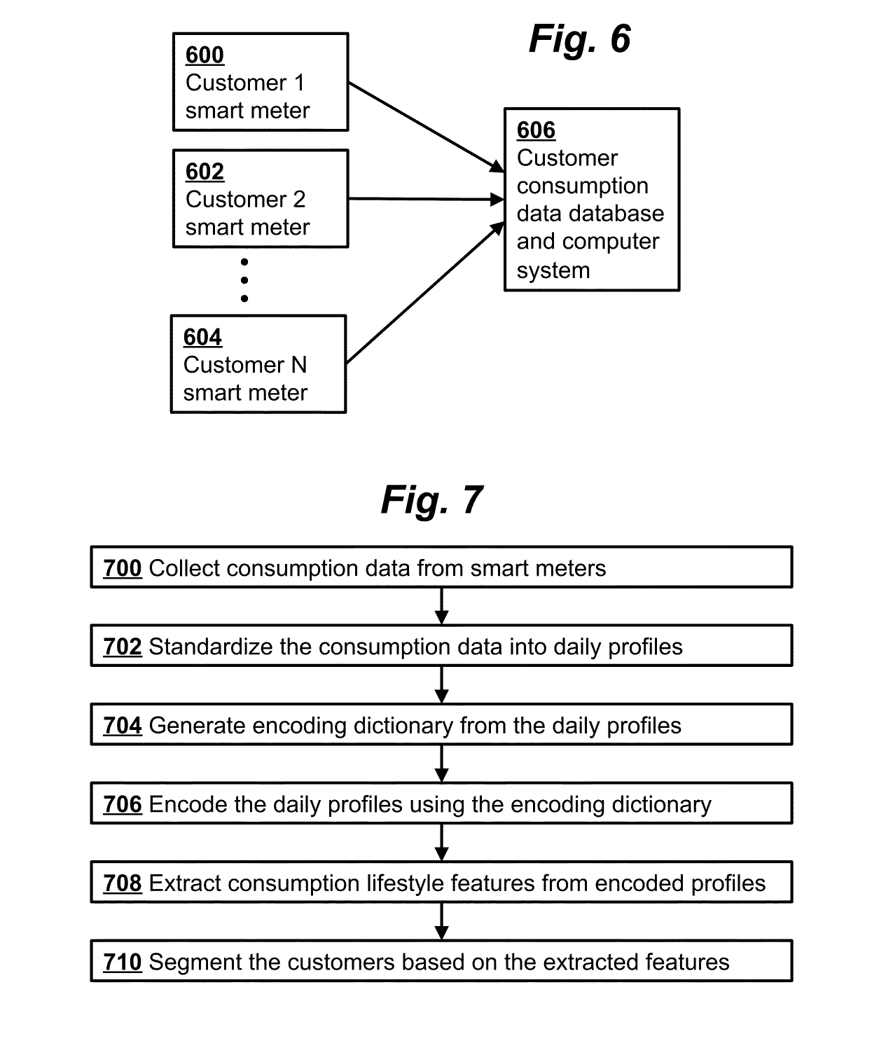

FIG. 6 is a schematic overview of a system implementing the method of the invention. Customer smart meter devices 600, 602, through 604 are installed at utility customer locations to produce time-series utility resource consumption data, preferably at high resolution, i.e., measurements at least once per hour, more preferably at least once per 15 minutes. The time series data, which includes customer identifier, resource use, and timestamp, are transmitted over a wired or wireless data connection to a database and computer system 606 which collects, stores, and analyzes the customer consumption data. Computer system 606 may comprise one or several computers to run all the encoding process, feature extraction and segmentation computation with interacting with a database server. To enhance the data transfer speed (incoming raw data or data exchange between different machines) and the computation speed, any advanced hardware specification can be implemented.

FIG. 7 outlines the main steps performed by the system according to a preferred embodiment. In step 700 the consumption data is collected from the smart meters. In step 702 the raw data collected from the smart meters is pre-processed using data cleansing techniques (anomaly detection with constraints, missing data imputation by linear interpolation or k-nearest neighbor algorithm), and standardization into daily profiles. In step 704 a load shape encoding dictionary is generated from a sample of the daily profiles. The dictionary is then used in step 706 to encode the daily profiles. In step 708 consumption features are extracted from the encoded data. The particular features extracted are selected depending on the objectives of the customer segmentation. In step 710 a clustering algorithm used to segment the customers based on the extracted features.

The methods of the present invention have application for utility policy and programs such as DR and EE. Using customer load shape profiles, we can effectively target residents that have the highest potential for benefiting from DR programs. Load shape based high potential targeting can have significant benefits: increased likelihood of success, energy savings, and public relations benefits from successful engagement in utility programs.

Load shape based energy use profiles that incorporate level of use and entropy offer other potential benefits. For example, recommendations for energy reduction, or critical peak pricing that are “lifestyle” based would be very different from the appliance and device based recommendation currently used by most utilities. Lifestyle recommendations include focusing on shapes such as morning and afternoon or only afternoon peaks and suggesting that they move activities earlier or later in the day. Since it is rare that a single load shape represents a lifestyle, lower energy or off peak load shapes within a household repertoire of shapes also could be recommended as a means of energy reduction and savings.

Beyond load shape segmentation, the extent of entropy within a household could yield further understanding of the potential of success for targeting and recommendation design. For example, high entropy households, indicating variability in occupancy and energy using activity, may have low potential for targeting for DR programs but high potential for energy reduction programs such as appliance rebates.

1. A method implemented by a computer for segmenting utility customers according to consumption lifestyle features, the method comprising:
collecting by the computer from smart meter sensors time-series utility consumption data from individual utility customers;
standardizing by the computer the collected time-series utility consumption data by dividing the time-series data into daily consumption profiles;
generating by the computer a utility customer consumption profile dictionary from the standardized data, where the dictionary comprises representative load shapes found using clustering;
encoding by the computer the standardized data, wherein the encoding comprises producing a series of dictionary codes using a distance metric and the dictionary of representative load shapes;
extracting by the computer consumption lifestyle features of the utility customers from the encoded data;
segmenting by the computer the customers based on the extracted features by clustering.

2. The method of claim 1 wherein the time-series utility consumption data represents resource use per unit time for each customer.

3. The method of claim 1 wherein the representative load shapes in the dictionary are found using adaptive K-means and hierarchical clustering.

4. The method of claim 1 wherein each of the lifestyle features of the utility customers is a dictionary code distribution vector for each customer.

5. The method of claim 1 wherein segmenting the customers comprises adaptive K-means clustering using a distance metric to measure the distance between feature lifestyle vectors.

6. The method of claim 1 further comprising using the segmentations of customers to estimate customer performance in a utility program.

7. The method of claim 1 further comprising presenting to customers information about their typical patterns of consumption and savings.

8. The method of claim 1 further comprising designing pricing of the utility resource based on the encoded patterns.

9. The method of claim 1 further comprising targeting customers with utility programs based on the segmentations.

10. The method of claim 1 further comprising implementing a load shape predictor to predict a future load shape from the encoded data, and predicting daily consumption from the predicted load shape and an estimate of daily total consumption.
